(19) United States
(12) Patent Application Publication
(10) Pub. No.: US 2016/0246143 A1
(43) Pub. Date: Aug. 25, 2016

(54) LIQUID CRYSTAL PANEL AND LIQUID CRYSTAL DISPLAY COMPRISING THE SAME

(71) Applicant: Shenzhen China Star Optoelectronics Technology Co., Ltd., Shenzhen, Guangdong (CN)

(72) Inventor: Hua Zheng, Shenzhen, Guangdong (CN)

(73) Assignee: Shenzhen China Star Optoelectronics Technology Co., Ltd., Shenzhen, Guangdong (CN)

(21) Appl. No.: 14/417,629

(22) PCT Filed: Jan. 19, 2015
(86) PCT No.: PCT/CN2015/071053

§ 371 Date: May 4, 2016

(30) Foreign Application Priority Data
Dec. 18, 2014 (CN) 201410802582.5

(51) Int. Cl. G02F 1/1362; G02F 1/1343; G02F 1/1335

(52) U.S. Cl. CPC G02F 1/136286; G02F 1/133514; G02F 1/134309; G02F 1/133512

(57) ABSTRACT

A liquid crystal panel in the technical field of display is proposed. The liquid crystal panel comprises a liquid crystal layer, and an array substrate and a color filter substrate respectively disposed on both sides of the liquid crystal layer. A gate line is arranged at an end of each pixel unit in a first direction of the array substrate. Two adjacent pixel units in the first direction are configured such that their gate lines are adjacent to each other or away from each other in opposite directions. A corresponding liquid crystal device is further proposed.

### CROSS REFERENCE TO RELATED APPLICATION

The present application claims benefit of Chinese patent application CN 201410802582.5, entitled “A Liquid Crystal Panel and A Liquid Crystal Display Device Comprising the Same” and filed on Dec. 18, 2014, the entirety of which is incorporated herein by reference.

### TECHNICAL FIELD

The present disclosure relates to the technical field of display, and in particular to a liquid crystal panel and a liquid crystal display device comprising the liquid crystal panel.

### TECHNICAL BACKGROUND

FIG. 1 shows a liquid crystal panel in the prior art. As shown in FIG. 1, because an array substrate 5 and a color filter substrate 6 (CF substrate) of a vertical alignment (VA) liquid crystal panel are fixed together by a frame around the four sides of the panel, relative shift would easily occur in a display area of the liquid crystal panel.

FIG. 2 shows a liquid crystal panel on which relative shift has occurred. As shown in FIG. 2, due to such relative shift, a black matrix 1 (BM) arranged on an interior side of the color filter substrate 6 cannot effectively cover up a light leaking region on the periphery of a gate line 3 of the array substrate 5, and light rays from a backlight will penetrate the liquid crystal panel. As a result, undesirable display of bright cloud under the black image would occur. Because such bright cloud will move as the liquid crystal display panel is impacted, it is usually called moving mura (MM).

An aperture ratio of a pixel unit refers to a ratio of an area of an effective region of the pixel unit, through which light can pass, to the total area thereof. When light is emitted from the backlight, not all of it can pass through the liquid crystal panel. For example, light cannot completely penetrate the locations where components, such as signal wirings for driving chips, thin film transistors themselves, and storage capacitors for storing voltage, and the like, are arranged. In addition to the incomplete transmittance of the abovementioned locations, because light passing through these locations is out of the control of the voltage, it is difficult for a correct gray scale to be displayed. In this case, said locations should be covered with a black matrix, so that other light permeable region would not be disturbed. The aperture ratio is a ratio of the area of the effective light permeable region to the total area of the pixel unit.

FIG. 3 shows an arrangement of the black matrix under ideal conditions. As shown in FIG. 3, under ideal conditions, in order to maximize the aperture ratio of a pixel, a black matrix 1 can desirably extend right to the edges of a maximum aperture region of a pixel electrode 2 (ITO) (the term “aperture region” refers to an effective region, through which light can pass, in each pixel electrode). That is, the edge of the black matrix 1 and that of the pixel electrode 2 are in the same vertical plane when observed along a direction of the thickness of the liquid crystal panel.

However, in order to prevent moving mura, it is a conventional approach that the black matrix 1 is widened. FIG. 4 shows an arrangement of a black matrix in the prior art. As shown in FIG. 4, the black matrix 1 covers a further distance M towards the interior of the pixel electrode 2, i.e., the extension of the black matrix 1 surpasses the edge of the pixel electrode 2 for a distance M.

The value of M is determined by the degree of shift between the array substrate 5 and the color filter substrate 6, and generally in a range of 0 to 30 μm. The degree of shift is determined by the specific parameters of the panel. The larger the relative shift is, the lower the probability of occurrence. The value of M can be typically in a range of 0 to 20 μm. The larger the value of M is, the larger the extra coverage by the black matrix 1, and thus the more the loss of aperture ratio.

FIG. 5 shows a pixel unit made through a five-mask process.

As shown in FIG. 5, a line frame 11 schematically shows a pixel unit. The line frame 11 comprises a gate 3 and a common electrode 8 (Com) formed by a first metal layer (Metal 1), and an active layer 13 of a thin film transistor (TFT) formed by amorphous silicon layer. The line frame 11 further comprises a data line 9 (Data) and a source and a drain of the TFT, which are formed by a second metal layer (Metal 2), a via hole 12 formed by a via hole layer for connecting the upper and lower metal layers, and a pixel electrode 2 (ITO region) formed by a pixel electrode layer.

In the pixel unit as shown in FIG. 5, no matter the thin film transistor is on or off, the gate line 3 would cause a positive or a negative large bias voltage with respect to the common electrode 8 of the color filter substrate 6, rendering the liquid crystals on both sides thereof to deflect, thereby forming light leaking regions.

Under ideal conditions, the gate line 3 and the light leaking regions around the gate line 3 will be blocked by the black matrix 1 arranged on the color filter substrate 6, and thus the display of black image will not be influenced.

However, in actual operation, relative shift between the color filter substrate 6 and the array substrate 5 of the liquid crystal panel would easily occur, thereby causing moving mura phenomenon. As shown in FIG. 4, in the prior art, in order to prevent moving mura, the black matrix 1 is widened, so that the aperture region can be covered for a further distance M by the black matrix 1.

As shown in FIG. 6, in conventional pixel design, because gate lines 3 are arranged on both an upper side and a lower side of each aperture region, a loss value of the area of the aperture region in each pixel unit equals to 2 M×W (W is the width of a pixel electrode at the extending part of the black matrix). Thus, the loss of aperture ratio is large.

### SUMMARY OF THE INVENTION

In order to solve the technical problem in the prior art of low utilization ratio of light due to large loss of aperture ratio caused by the design of the black matrix of the liquid crystal panel, an improved liquid crystal panel is proposed according to the present disclosure.

In embodiment 1 according to the present disclosure, a liquid crystal panel comprises a liquid crystal layer, and an array substrate and a color filter substrate respectively disposed on both sides of the liquid crystal layer, wherein a gate line is arranged at an end of each pixel unit in a first direction of the array substrate, and a black matrix corresponding to the gate line is arranged on a side of the color filter substrate facing the liquid crystal layer, and wherein two adjacent pixel units in the first direction are configured such that their gate lines are adjacent to each other or away from each other in opposite directions.

In a pixel designed in the prior art, because gate lines are arranged on both an upper side and a lower side of each aperture region, the loss of an area of the aperture region in each pixel unit equals to 2 M×W (W is a width of a pixel electrode at an extending region of the black matrix), rendering large loss of aperture ratio.

When the pixel units are arranged in a manner according to the present disclosure, an aperture region of each pixel is adjacent to only one gate line. In this case, under the condition that the black matrix is also widened for a distance M, the loss of an area of the aperture region in each pixel unit is only M×W, which is half of that under conventional design.

In embodiment 2 which is improved based on embodiment 1, in a column of pixel units along the first direction, a (2n−1)^{th} pixel unit and a 2n^{th} pixel unit are configured such that their gate lines are adjacent to each other, with 0<n≦(a total number of pixel units in the column)/2, n being a positive integer.

In embodiment 3 which is improved based on embodiment 1, in a column of pixel units along the first direction, a 2n^{th} pixel unit and a (2n+1)^{th} pixel unit are configured such that their gate lines are adjacent to each other, with 0<n≦[(a total number of pixel units in the column)/2½], n being a positive integer.

In embodiment 4 which is improved based on any one of embodiments 1 to 3, each black matrix is structured to cover two adjacent gate lines corresponding thereto.

In embodiment 5 which is improved based on any one of embodiments 1 to 4, both ends of the black matrix in the first direction each extend beyond an edge of each of pixel electrodes corresponding to said two pixel units for a distance.

The degree of shift between the array substrate and the color filter substrate is determined by the specific parameters of the panel, and generally in a range of 0 to 30 μm.

The larger the relative shift is, the lower the probability of occurrence. The distance of extension of the black matrix beyond the edge of the pixel electrode can be determined by the degree of relative shift between the array substrate and the color filter substrate.

In embodiment 6 which is improved based on embodiment 5, the distance is in a range of 0-30 μm.

In embodiment 7 which is improved based on embodiment 5 or embodiment 6, the distance is in a range of 0-20 μm.

In embodiment 8 which is improved based on any one of embodiments 1 to 7, in a second direction perpendicular to the first direction, pixel units in a same line are configured with a same orientation.

In embodiment 9 which is improved based on any one of embodiments 1 to 8, in the second direction perpendicular to the first direction, gate lines of the pixel units in the same line are aligned with one another.

A liquid crystal display device comprising the liquid crystal panel is further proposed according to the present disclosure.

In the liquid crystal panel and the display device according to the present disclosure, each two adjacent pixel units in the first direction constitute a group and are arranged in such a manner that their gate lines abut against each other. In other words, one of said two adjacent pixel units is placed “upside down”.

With such arrangements of the pixels, the aperture region of each pixel unit is adjacent to only one gate line. Thus, under the condition that the black matrix is also widened for a distance M, the loss of the area of the aperture region of each pixel unit is merely M×W, which is half of that under conventional design in the prior art.

The arrangements of pixel units are adjusted according to the present disclosure, such that gate lines of two adjacent pixel units in the first direction are disposed at the junction therebetween, thereby the loss of the area of the aperture region caused by the widened black matrix can be reduced by half Therefore, while moving mura is eliminated, the loss of aperture ratio can also be reduced according to the present disclosure.

As long as the objective of the present disclosure is met, the above technical features can be combined together in any suitable manner or replaced with equivalent technical features.

### BRIEF DESCRIPTION OF THE ACCOMPANYING DRAWINGS

The present disclosure will be described in detail based on the non-limiting examples and the accompanying drawings. In the drawings:

FIG. 1 shows a liquid crystal panel in the prior art,

FIG. 2 shows a liquid crystal panel with relative shift between an array substrate and a color filter substrate,

FIG. 3 shows a structure of a liquid crystal panel under ideal conditions,

FIG. 4 shows a structure of the liquid crystal panel in the prior art,

FIG. 5 schematically shows a pixel unit,

FIG. 6 shows the working principle of a black matrix in the prior art, and

FIG. 7 shows an arrangement of pixel units of a liquid crystal panel according to the present disclosure.

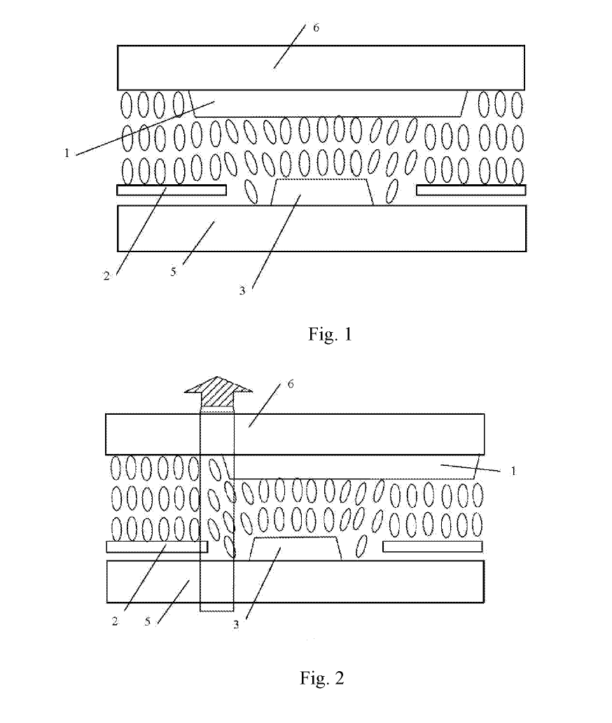

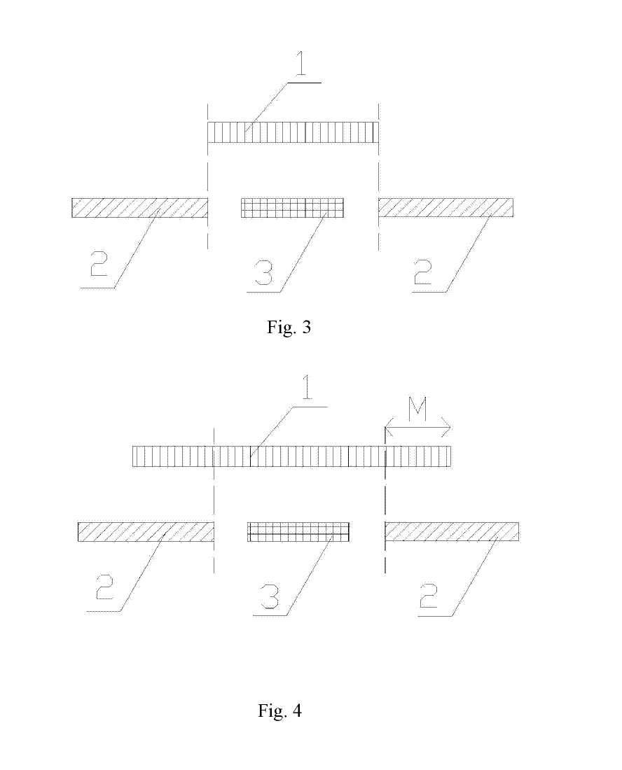

In the drawings, same components are indicated with the same reference sign. The drawings are not drawn to actual scale.

### DETAILED DESCRIPTION OF THE EMBODIMENTS

The present disclosure will be described in detail with reference to the accompanying drawings.

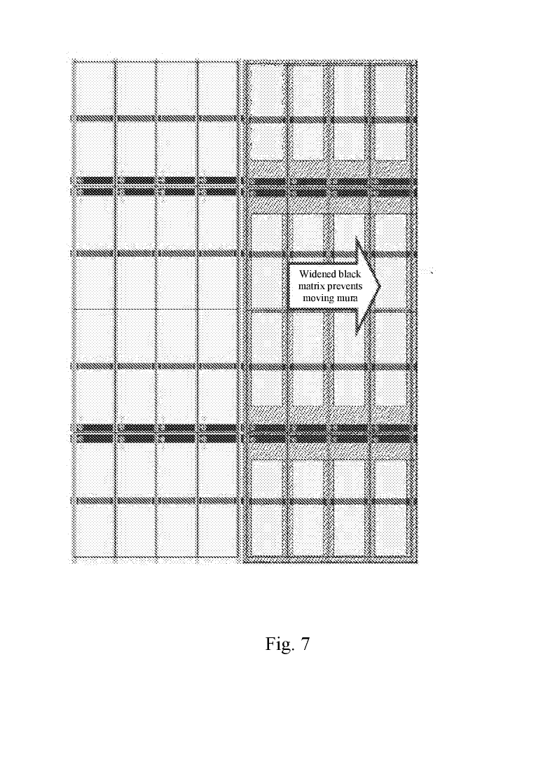

As shown in FIG. 7, a liquid crystal panel is proposed according to the present disclosure.

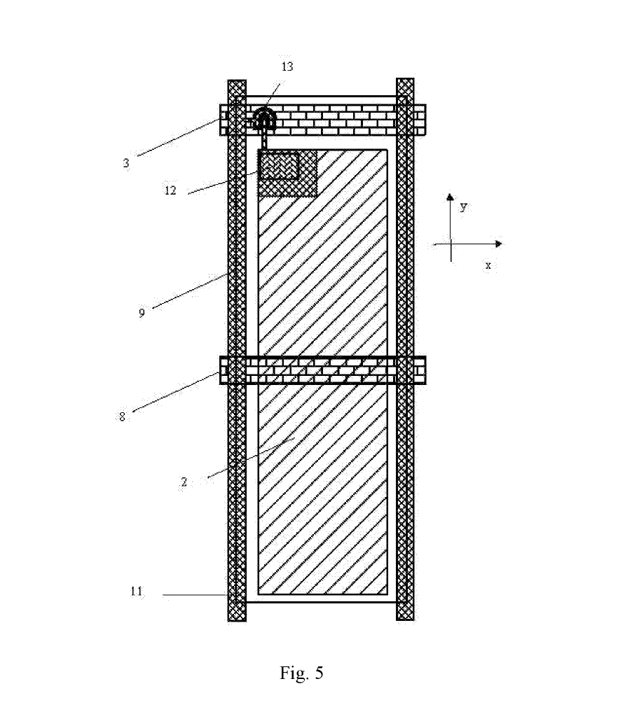

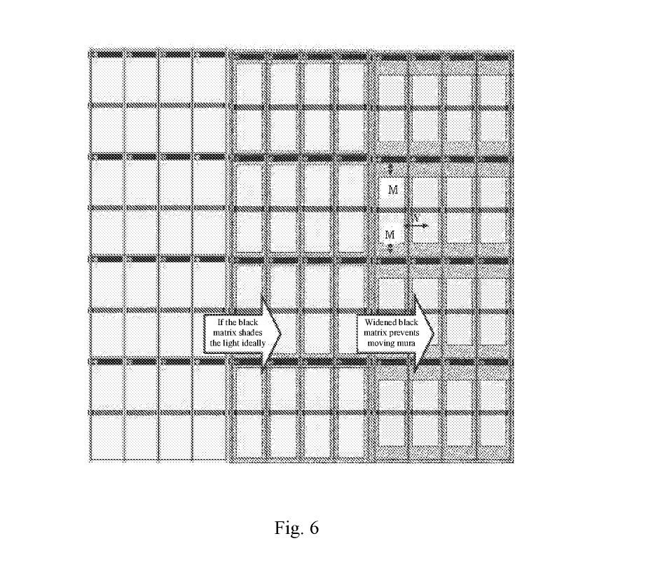

The liquid crystal panel comprises a liquid crystal layer, and an array substrate and a color filter substrate respectively disposed on both sides of the liquid crystal layer. A gate line is arranged at an end in a first direction of each pixel unit of the array substrate, and a black matrix corresponding to the gate line is arranged on a side of the color filter substrate facing the liquid crystal layer. The first direction is the direction indicated by axis y in the coordination system as shown in FIG. 5.

As shown in FIG. 7, two adjacent pixel units in the first direction are configured such that their gate lines are adjacent to each other or away from each other in opposite directions. In other words, one of the two adjacent pixel units in the first direction is place upside down.

In a column of pixel units along the first direction, a (2n−1)^{th} pixel unit and a 2n^{th} pixel unit are configured such that their gate lines are adjacent to each other, with 0<n<(a total number of pixel units in the column)/2, n being a positive integer. In other words, when the total number of pixel units in a column in the first direction is even, each two pixel units form a group and are respectively arranged in opposite orientations. When the total number of pixel units in a column in the first direction is odd, each two pixel units of all pixel units except for the last one form a group and are respectively arranged in opposite orientations, and the last pixel unit can be arranged in any manner.

The pixel units can also be arranged in the following manner. In a column of pixel units along the first direction, a 2n^{th} pixel unit and a (2n+1)^{th} pixel unit are configured such that their gate lines are adjacent to each other, with 0<n≦[(a total number of pixel units in the column)/2½], n being a positive integer. That is, when the total number of pixel units in a column in the first direction is odd, the first pixel unit is arranged in an optional manner, and each two of the rest pixel units form a group and are respectively arranged in opposite orientations.

In a second direction perpendicular to the first direction, pixel units in a same line are configured with a same orientation. As shown in FIG. 5, the second direction is the direction indicated by an axis x in a coordination system. Preferably, in the second direction, gate lines of the pixel units in the same line are aligned with one another.

In order to eliminate the defect of light leakage near the gate lines, each black matrix is configured to cover two adjacent gate lines corresponding thereto. In order to prevent light leakage caused by the relative shift between the color filter substrate and the array substrate, both ends of the black matrix in the first direction each extend beyond an edge of each of pixel electrodes corresponding to said two pixel units for a certain distance. The degree of relative shift between the array substrate and the color filter substrate is determined by the specific parameters of the panel. The distance can be selected in a range of 0-30 μm based on the average degree of relative shift between the array substrate and the color filter substrate. Preferably, the distance is in a range of 0-20 μm.

In addition, a liquid crystal display device comprising the liquid crystal panel is proposed according to the present disclosure.

In the prior art, the pixel units on the liquid crystal panel are repeatedly arranged, i.e., the gate line in each of the pixel units is arranged in the same manner.

As shown in FIG. 7, in the liquid crystal panel according to the present disclosure, each two adjacent pixel units in the first direction (the direction indicated by an axis y in the coordination system as shown in FIG. 5) constitute a group, and are arranged in such a manner that their gate lines abut against each other. In other words, one of said two adjacent pixel units is placed “upside down”.

With such arrangements of the pixels, the aperture region of each pixel unit is adjacent to only one gate line. Thus, under the condition that the black matrix is also widened for a distance M, the loss of the area of the aperture region of each pixel unit is merely M×W, which is half of that under conventional design in the prior art.

According to the present disclosure, the arrangements of pixel units are adjusted such that gate lines for two adjacent pixel units in the first direction are disposed at the junction therebetween, thereby the loss of the area of the aperture region caused by the widened black matrix can be reduced by half Therefore, while moving mura is eliminated, the loss of aperture ratio can also be reduced according to the present disclosure.

Although the present disclosure has been described with reference to preferred embodiments, various modifications and variants to the present disclosure may be made by anyone skilled in the art, without departing from the scope and spirit of the present disclosure. The present disclosure is not limited to the specific examples disclosed herein, but rather includes all the technical solutions falling within the scope of the claims.

1. A liquid crystal panel, comprising a liquid crystal layer, and an array substrate and a color filter substrate respectively disposed on both sides of the liquid crystal layer, wherein a gate line is arranged at an end of each pixel unit in a first direction of the array substrate, and a black matrix corresponding to the gate line is arranged on a side of the color filter substrate facing the liquid crystal layer, and wherein two adjacent pixel units in the first direction are configured such that their gate lines are adjacent to each other or away from each other in opposite directions.

2. The liquid crystal panel according to claim 1, wherein in a column of pixel units along the first direction, a (2n−1)^{th} pixel unit and a 2n^{th} pixel unit are configured such that their gate lines are adjacent to each other, with 0<n≦(a total number of pixel units in the column)/2, n being a positive integer.

3. The liquid crystal panel according to claim 1, wherein in a column of pixel units along the first direction, a 2n^{th} pixel unit and a (2n+1)^{th} pixel unit are configured such that their gate lines are adjacent to each other, with 0<n<[(a total number of pixel units in the column)/2½], n being a positive integer.

4. The liquid crystal panel according to claim 1, wherein each black matrix is structured to cover two adjacent gate lines corresponding thereto.

5. The liquid crystal panel according to claim 4, wherein both ends of the black matrix in the first direction each extend beyond an edge of each of pixel electrodes corresponding to said two pixel units for a distance.

6. The liquid crystal panel according to claim 5, wherein the distance is in a range of 0-30 μm.

7. The liquid crystal panel according to claim 6, wherein the distance is in a range of 0-20 μm.

8. The liquid crystal panel according to claim 1, wherein in a second direction perpendicular to the first direction, pixel units in a same line are configured with a same orientation.

9. The liquid crystal panel according to claim 2, wherein in the second direction perpendicular to the first direction, pixel units in the same line are configured with the same orientation.

10. The liquid crystal panel according to claim 3, wherein in the second direction perpendicular to the first direction, pixel units in the same line are configured with the same orientation.

11. The liquid crystal panel according to claim 1, wherein in the second direction perpendicular to the first direction, gate lines of the pixel units in the same line are aligned with one another.

12. The liquid crystal panel according to claim 2, wherein in the second direction perpendicular to the first direction, gate lines of the pixel units in the same line are aligned with one another.

13. The liquid crystal panel according to claim 3, wherein in the second direction perpendicular to the first direction, gate lines of the pixel units in the same line are aligned with one another.

14. A liquid crystal display device, comprising a liquid crystal panel having a liquid crystal layer, and an array substrate and a color filter substrate respectively disposed on both sides of the liquid crystal layer, wherein a gate line is arranged at an end of each pixel unit in a first direction of the array substrate, and a black matrix corresponding to the gate line is arranged on a side of the color filter substrate facing the liquid crystal layer, and wherein two adjacent pixel units in the first direction are configured such that their gate lines are adjacent to each other or away from each other in opposite directions.
